(19) United States
(12) Patent Application Publication
(10) Pub. No.: US 2019/0288589 A1
(43) Pub. Date: Sep. 19, 2019

(54) SYSTEM AND INSTALLATION FOR GENERATING A THREE-PHASE ALTERNATING VOLTAGE

(71) Applicant: Siemens Aktiengesellschaft, Munich (DE)

(72) Inventors: Christian Jäkel, Duisburg (DE); Meinolf Klocke, Witten (DE); Christoph Lehmann, Neukirchen-Vluyn (DE); Marian-Peter Pieczyk, Mülheim a.d. Ruhr (DE); Holger Romanowski, Duisburg (DE); Milan Schmahl, Mülheim an der Ruhr (DE)

(73) Assignee: Siemens Aktiengesellschaft, Munich (DE)

(21) Appl. No.: 16/301,559

(22) PCT Filed: Apr. 18, 2017
(86) PCT No.: PCT/EP2017/059182

§ 371 Date: Nov. 14, 2018

(30) Foreign Application Priority Data
May 18, 2016 (EP) 16170135.4

(51) Int. Cl. H02K 19/32; H02K 3/28; F01D 15/10; H02K 1/22

(52) U.S. Cl. CPC H02K 19/32; H02K 1/22; F01D 15/10; H02K 3/28

(57) ABSTRACT

A three-phase generator for an installation for generating a three-phase alternating voltage, has a two-pole rotor having two magnetic poles, wherein the magnetic poles are arranged irregularly and offset to one another on the periphery with respect to a rotor rotational axis of the rotor

### CROSS REFERENCE TO RELATED APPLICATIONS

This application is the US National Stage of International Application No. PCT/EP2017/059182 filed Apr. 18, 2017, and claims the benefit thereof. The International Application claims the benefit of European Application No. EP16170135 filed May 18, 2016. All of the applications are incorporated by reference herein in their entirety.

### FIELD OF INVENTION

The invention relates to a system and a plant for generating a three-phase AC voltage.

### BACKGROUND OF INVENTION

Plants for generating a three-phase AC voltage and for supplying the three-phase AC voltage to a power grid are well known and are used in power plants. A plant of this kind can have at least one turbine and at least one three-phase generator, in particular a turbogenerator, which is driven by way of the turbine. The turbine may be, for example, a gas turbine of a combined cycle gas turbine (CCGT) plant or of a gas turbine plant or a steam turbine of a steam turbine power plant.

A turbine rotor of the turbine is usually connected to a rotor of the three-phase generator in a rigid or rotationally fixed manner. In order to be able to use the three-phase generator to generate a three-phase AC voltage at a conventional grid frequency of 50 Hz or 60 Hz through rotation of the turbine rotor and to feed said three-phase AC voltage into a power grid, the turbine rotor usually has to rotate at an operating frequency of 50 Hz or 60 Hz.

Since the power and the efficiency of gas turbines at an operating frequency of 50 Hz (50 Hz gas turbines) are greater than in the case of corresponding 60 Hz gas turbines, there is an interest in also using 50 Hz gas turbines to supply power to power grids at a grid frequency of 60 Hz (60 Hz power grids).

The publication “Cogging Torque in Cost-Effective Surface-Mounted Permanent-Magnet Machines”, Young Pang et al., IEEE Transactions on Magnetics, IEEE Service Center, New York, N.Y., US, Vol. 47, No. 9, Sep. 1, 2011, pages 2269-2276 discloses configurations of a rotating electric machine having a two-pole rotor, by way of which a cogging torque can be reduced.

The publication “Design Techniques for Reducing the Cogging Torque in Surface-Mounted PM Motors”, Nicola Bianchi et al., IEEE Transactions on Industry Applications, IEEE Service Center, Piscataway, N.J., US, Vol. 38, No. 5, Sep. 1, 2002 discloses configurations of a rotating electric machine, by way of which a cogging torque can be reduced. Permanent magnets of a rotor of the machine can be arranged in a manner offset with respect to one another for this purpose.

### SUMMARY OF INVENTION

It is an object of the invention to enable the usability of turbines whose operating frequency is lower than the grid frequency of a power grid in order to supply electrical energy to the power grid.

A system according to the invention for generating a three-phase AC voltage comprises at least one three-phase generator having a two-pole rotor having two magnetic poles, which are arranged, with respect to the rotor axis of rotation of the rotor, in an unevenly circumferentially offset manner with respect to one another, and at least one filter unit, which can be used to filter phase voltages of a three-phase AC voltage generated by way of the three-phase generator.

Owing to the uneven circumferential offset of the two magnetic poles of the rotor of the three-phase generator according to the invention, the magnetic poles of the rotor do not lie on a common axis running perpendicular to the rotor axis of rotation of the rotor, that is to say are not at a usual pole spacing of 180° with respect to one another. Instead, an obtuse or acute angle is arranged between an axis connecting one magnetic pole to the rotor axis of rotation and an axis connecting the other magnetic pole to the rotor axis of rotation. This leads to one magnetic pole following the other magnetic pole in the direction of rotation of the rotor at a pole spacing increased or decreased compared to 180°. This induces in a stator winding of a stator of the three-phase generator a relatively greatly distorted oscillation compared to a usual, approximately sinusoidal oscillation. Said oscillation is characterized in that the first half-wave proceeds faster or slower than the second half-wave. A Fourier decomposition of said induced voltage contains various oscillation components in various frequency ranges. Depending on the grid frequency of the respective power grid into which the three-phase AC voltage is intended to be fed, those oscillation components that are not required for this infeeding, in particular all of the oscillation components outside of the oscillation whose frequency corresponds to the grid frequency, can be filtered out of the induced voltage by a suitable filter circuit. The filter unit may have a filter circuit that is adapted to the three-phase AC voltage generated by way of the three-phase generator and to the grid frequency of a power grid to be supplied therewith.

To form the rotor, a specific rotor can be produced. As an alternative, recourse may be made to a conventional rotor but the rotor windings thereof are changed in order to achieve an uneven circumferential offset of the magnetic poles of the rotor. A conventional rotor of this kind can be balanced mechanically by suitable measures, for example by virtue of possibly present non-wound grooves of the rotor being filled with replacement bodies.

The three-phase generator according to the invention can be used in plants for generating a three-phase AC voltage in which the operating frequency of the turbine rotor or the drive rotational speed generated by way of the turbine may arbitrarily be below the grid frequency of the power grid into which the three-phase AC voltage is intended to be fed. In this case, only the pole spacing between the magnetic poles of the rotor has to be adapted to the respective difference between the operating frequency of the turbine rotor and the grid frequency of the power grid.

When using the three-phase generator according to the invention, for example, a 60 Hz three-phase AC voltage can be generated using a 50 Hz gas turbine that drives the rotor of the three-phase generator. As a result, 50 Hz gas turbines can thus be used to supply power to 60 Hz power grids. As an alternative, a 50 Hz steam turbine can also be used accordingly to supply power to 60 Hz power grids.

The power and the efficiency of a plant provided with a three-phase generator according to the invention are higher compared to a conventional 60 Hz gas turbine unit. Since the maximum power of a 50 Hz gas turbine is 44% greater than the maximum power of a corresponding 60 Hz gas turbine, for example, larger 60 Hz power plants can be designed with fewer blocks. For example, power plants that until now have been implemented with four 60 Hz gas turbine CCGT sections can now be implemented with three 50 Hz gas turbine CCGT sections when using the three-phase generator according to the invention. As a result, an entire section consisting of gas turbine, generator, switching coupling, tank, steam turbines and process control technology is omitted, which leads to an enormous cost saving.

A pole angular spacing between the magnetic poles in the direction of rotation of the rotor is advantageously 210°. As a result, the first half-wave of a voltage oscillation induced in the stator winding proceeds faster than the second half-wave of the voltage oscillation. In this case, the magnetic south pole of the rotor can be arranged, for example, angled by 30° with respect to an axis running perpendicular to the rotor axis of rotation and on which the magnetic north pole of the rotor lies. This leads to the magnetic south pole following the magnetic north pole in the opposite direction of rotation of the rotor as early as at a pole spacing of 150°. The first half-wave of a voltage oscillation induced in the stator winding can then correspond, for example, approximately to a 60 Hz half-wave, whereas the second half-wave of the voltage oscillation can correspond, for example, to a 40 Hz half-wave. A Fourier decomposition of said induced voltage contains, in addition to other oscillation components, a 40 Hz, a 50 Hz and a 60 Hz oscillation. This configuration of the rotor induces in the stator winding a relatively greatly distorted oscillation compared to a usual, approximately sinusoidal 50 Hz oscillation. Said oscillation is characterized in that the first half-wave of the oscillation proceeds faster than the second half-wave. In order to be able to supply the three-phase AC voltage to a 60 Hz power grid, all of the oscillation components that are not required, that is to say all of the oscillation components outside of the 60 Hz oscillation, can be filtered out of the induced voltage by way of a suitable filter circuit.

The three-phase generator advantageously comprises a stator having at least one fractional-pitch stator winding. Through a suitable configuration of the fractional pitch of the stator winding, the rotating magnetic fields rotating in the air gap between the rotor and a stator of the three-phase generator can be filtered. As an alternative or in addition, said filtering can also be achieved by a suitable other, in particular geometric, configuration of the stator winding. Said filtering can reduce undesired oscillation components in the three-phase AC voltage generated by way of the three-phase generator.

The stator is advantageously a 60 Hz stator and the rotor is advantageously a 50 Hz rotor. This means that the stator is a stator of a three-phase generator whose operating frequency is 60 Hz and that the rotor is a rotor of a three-phase generator whose operating frequency is 50 Hz. The 50 Hz rotor is driven by way of a 50 Hz turbine.

The filter unit advantageously comprises one series resonant circuit per phase of the three-phase AC voltage generated by way of the three-phase generator. Each series resonant circuit comprises a capacitance and an inductance, which are coordinated with the respective filtering, in order to be able to feed to the respective power grid a three-phase AC voltage whose frequency corresponds to the grid frequency of the power grid.

A plant according to the invention for generating a three-phase AC voltage comprises at least one turbine and at least one system as per one of the configurations mentioned above or an arbitrary combination of the same, wherein a turbine rotor of the gas turbine is connected to the rotor of the three-phase generator in a rotationally fixed manner, and wherein an operating frequency of the turbine rotor is lower than a frequency of the three-phase AC voltage filtered by way of the filter unit.

The advantages mentioned above with respect to the system are accordingly connected with the plant. The turbine may be a gas turbine or a steam turbine. In particular, the turbine may be a 50 Hz turbine. The three-phase generator and the filter unit may be configured in such a way that a 60 Hz three-phase AC voltage can be generated with a rotor of the three-phase generator rotating at 50 Hz.

### BRIEF DESCRIPTION OF THE DRAWINGS

The invention is explained by way of example below with reference to the attached figures on the basis of advantageous embodiments, wherein the features depicted below may constitute an aspect of the invention both taken alone and in different combinations with one another. In the figures:

FIG. 1 shows a schematic illustration of an exemplary embodiment of a three-phase generator according to the invention; and

FIG. 2 shows a schematic illustration of an exemplary embodiment of a plant according to the invention.

### DETAILED DESCRIPTION OF INVENTION

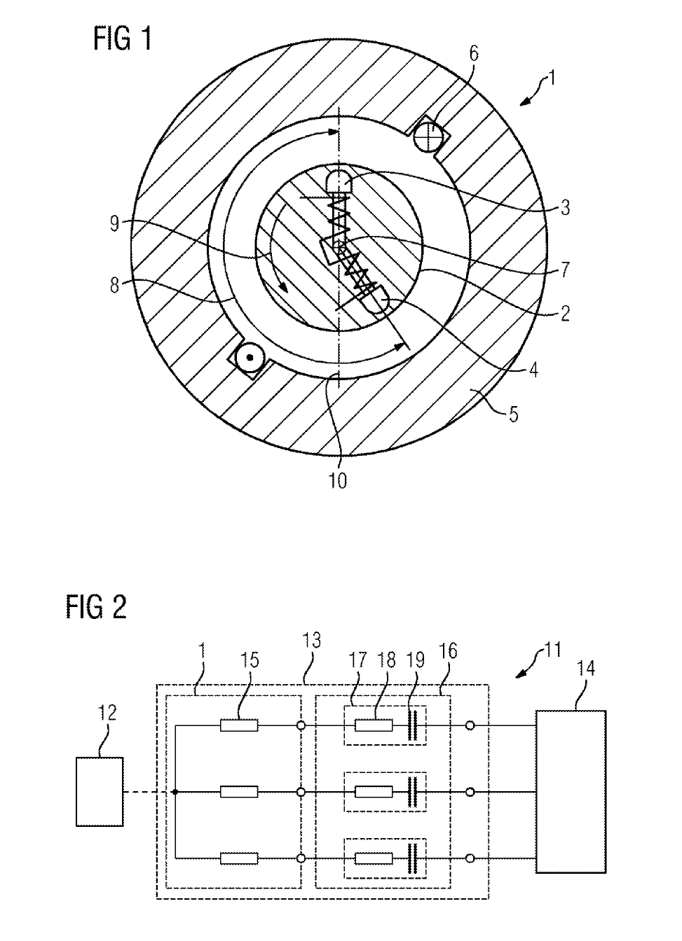

FIG. 1 shows a schematic cross-sectional illustration of an exemplary embodiment of a three-phase generator 1 according to the invention for a plant (not shown) for generating a three-phase AC voltage.

The three-phase generator 1 comprises a two-pole rotor 2 having two magnetic poles 3 and 4, wherein the magnetic pole 3 is a magnetic north pole and the magnetic pole 4 is a magnetic south pole. The three-phase generator 1 also comprises a stator 5, which has an, in particular fractional-pitch, stator winding 6, in which a voltage is induced owing to the rotation of the rotor 2 about the rotor axis of rotation 7 thereof. The stator 5 is a 60 Hz stator and the rotor 2 is a 50 Hz rotor.

The magnetic poles 3 and 4 are arranged, with respect to the rotor axis of rotation 7 of the rotor 2, in an unevenly circumferentially offset manner with respect to one another. In particular, the magnetic poles 3 and 4 are arranged, with respect to the rotor axis of rotation 7 of the rotor 2, in an unevenly circumferentially offset manner with respect to one another in such a way that a pole angular spacing 8 between the magnetic poles 3 and 4 in a direction of rotation (indicated by an arrow 9) of the rotor 2 is greater than 180°. In particular, the pole angular spacing 8 in the direction of rotation of the rotor 2 in the exemplary embodiment shown is 210°. The magnetic pole 4 of the rotor 2 is thus arranged angled by 30° with respect to an axis 10 running perpendicular to the rotor axis of rotation 7 and on which the magnetic pole 3 of the rotor 2 lies. Therefore, the magnetic pole 4 follows the magnetic pole 3 in the opposite direction of rotation of the rotor 2 as early as at a pole spacing of 150°. The first half-wave of a voltage oscillation induced in the stator winding 6 corresponds approximately to a 60 Hz half-wave, whereas the second half-wave of the voltage oscillation corresponds approximately to a 40 Hz half-wave. The first half-wave of the oscillation proceeds faster than the second half-wave. A Fourier decomposition of said induced voltage contains, in addition to other oscillation components, a 40 Hz, a 50 Hz and a 60 Hz oscillation. This configuration of the rotor 2 induces in the stator winding 6 a relatively greatly distorted oscillation compared to a usual, approximately sinusoidal 50 Hz oscillation. In order to be able to supply a 60 Hz three-phase AC voltage to a 60 Hz power grid, all of the oscillation components that are not required, that is to say all of the oscillation components outside of the 60 Hz oscillation, are filtered out of the induced voltage by way of a filter circuit (not shown).

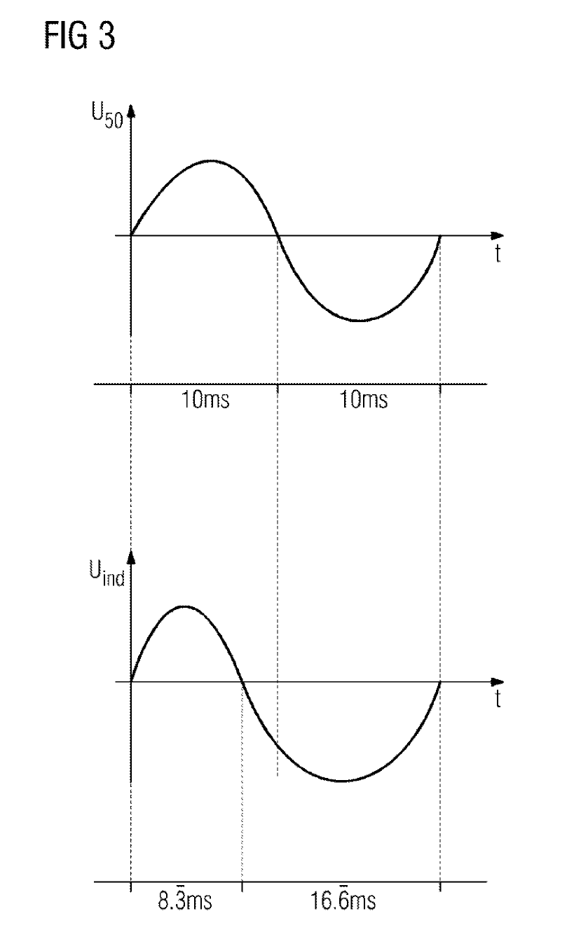

FIG. 2 shows a schematic illustration of an exemplary embodiment of a plant 11 according to the invention for generating a three-phase AC voltage.

The plant 11 comprises a turbine 12 in the form of a 50 Hz gas turbine. The plant 11 furthermore comprises a system 13 for generating the three-phase AC voltage. The system 13 is connected to a 60 Hz power grid 14 into which the 60 Hz three-phase AC voltage is intended to be fed.

The system 13 comprises a three-phase generator 1, which may be configured as per FIG. 1. From the three-phase generator 1, only a stator circuit diagram having three winding resistors 15 representing the stator winding is shown in FIG. 2. A turbine rotor (not shown) of the turbine 12 is connected to the rotor (not shown) of the three-phase generator 1 in a rotationally fixed manner.

The plant furthermore comprises a filter unit 16, which can be used to filter phase voltages generated by way of the three-phase generator 1. The filter unit 16 comprises one series resonant circuit 17 per phase of the three-phase AC voltage generated by way of the three-phase generator 1. Each series resonant circuit 17 comprises an inductance 18 and a capacitance 19. An operating frequency of the turbine rotor is lower than a frequency of the three-phase AC voltage filtered by way of the filter unit 16.

Although the invention has been described and illustrated in more detail by way of the advantageous exemplary embodiments, the invention is not restricted by the disclosed examples, and other variations may be derived herefrom by a person skilled in the art without departing from the scope of protection of the invention.

1. A system for generating a three-phase AC voltage, comprising:
at least one three-phase generator having a two-pole rotor having two magnetic poles, which are arranged, with respect to a rotor axis of rotation of the rotor, in an unevenly circumferentially offset manner with respect to one another, and
at least one filter unit, adapted to filter phase voltages of a three-phase AC voltage generated by way of the three-phase generator.

2. The system as claimed in claim 1,
wherein a pole angular spacing between the magnetic poles in a direction of rotation of the rotor is 210°.

3. The system as claimed in claim 1, further comprising:
a stator having at least one fractional-pitch stator winding.

4. The system as claimed in claim 3,
wherein the stator is a 60 Hz stator and the rotor is a 50 Hz rotor.

5. The system as claimed in claim 1,
wherein the filter unit has one series resonant circuit per phase of the three-phase AC voltage generated by way of the three-phase generator.

6. A plant for generating a three-phase AC voltage, comprising:
at least one turbine, and
at least one system as claimed in claim 1,
wherein a turbine rotor of the turbine is connected to the rotor of the three-phase generator in a rotationally fixed manner,
wherein an operating frequency of the turbine rotor is lower than a frequency of the three-phase AC voltage filtered by way of the filter unit.
